(19) United States
(12) Patent Application Publication
(10) Pub. No.: US 2026/0149327 A1
(43) Pub. Date: May 28, 2026

(54) ELECTRIC ACTUATOR

(71) Applicant: NIDEC POWERTRAIN SYSTEMS CORPORATION, Kanagawa (JP)

(72) Inventor: Hiroshi SHIRAI, Kanagawa (JP)

(73) Assignee: NIDEC POWERTRAIN SYSTEMS CORPORATION, Kanagawa (JP)

(21) Appl. No.: 19/177,642

(22) Filed: Apr. 14, 2025

(30) Foreign Application Priority Data
Apr. 15, 2024 (JP) 2024-065380

(51) Int. Cl. H02K 5/04; H02K 7/116

(52) U.S. Cl. CPC H02K 5/04; H02K 7/116

(57) ABSTRACT

An electric actuator includes: a motor having a rotor and accommodated in a housing including: a first housing, having an opening on one side in a first direction; and a second housing, blocking the opening and fixed to the first housing. The first housing has: an annular groove, surrounding the opening, and recessed toward an other side in the first direction; positioning parts, protruding from an inner surface of the groove toward a direction intersecting the first direction. The second housing has an annular protrusion, protruding toward the other side, disposed inside the groove, and fixed to the inner surface of the groove by an adhesive. The positioning parts has: first positioning parts facing a first surface facing the opening in an outer surface of the protrusion; and second positioning parts facing a second surface facing a side opposite to the first surface in the outer surface of the protrusion.

### CROSS REFERENCE TO RELATED APPLICATIONS

The present invention claims priority under 35 U.S.C. § 119 to Japanese Application No. 2024-065380 filed on Apr. 15, 2024 the entire content of which is incorporated herein by reference.

### FIELD OF THE INVENTION

The invention relates to an electric actuator.

### BACKGROUND

An electronic control device is known that includes a housing configured by joining a case having a seal groove on a joining surface and a cover having a fixing ridge engaged with the seal groove, through an adhesive filled in the seal groove.

In the electronic control device, in order to enhance the adhesive strength between the inner surface of the seal groove and the fixing ridge, it is necessary to adhere the fixing ridge positioned along the center of the seal groove. Therefore, in the electronic control device, at the time of curing the adhesive, a positioning jig for determining the position of the cover relative to the case may be necessary to position the fixing ridge at the center of the seal groove. In such case, there is a risk that the manufacturing cost of a potential control device may increase due to the increase in equipment cost required for manufacturing the electronic control device.

### SUMMARY

An aspect of an electric actuator of the invention includes: a motor part, having a rotor capable of rotating with a motor axis as a center; and a housing, accommodating the motor part in the housing. The housing has: a first housing, having an opening part open on one side in a first direction; and a second housing, blocking the opening part and fixed to the first housing. The first housing has: a groove part, having an annular shape, surrounding the opening part, and recessed toward an other side in the first direction; and multiple positioning parts, protruding from an inner surface of the groove part toward a direction intersecting the first direction. The second housing has a protrusion part having an annular shape, protruding toward the other side in the first direction, and disposed inside the groove part. The positioning parts has multiple first positioning parts and multiple second positioning parts, the first positioning parts facing a first surface that faces a side of the opening part in an outer surface of the protrusion part, and the second positioning parts facing a second surface that faces a side opposite to the first surface in the outer surface of the protrusion part. The protrusion part is fixed to the inner surface of the groove part by an adhesive.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a first perspective view showing an electric actuator according to an embodiment.

FIG. 2 is a first cross-sectional view showing an electric actuator according to an embodiment.

FIG. 3 is a second cross-sectional view showing an electric actuator according to an embodiment.

FIG. 4 is a perspective view showing a portion of an electric actuator according to an embodiment.

FIG. 5 is a plan view of a portion of an electric actuator according to an embodiment when viewed from one side in a first direction.

FIG. 6 is a second perspective view showing an electric actuator according to an embodiment.

FIG. 7 is a third cross-sectional view showing an electric actuator according to an embodiment.

FIG. 8 is a plan view of a second housing according to an embodiment when viewed from the other side in the first direction.

FIG. 9 is a cross-sectional view showing a portion of an electric actuator according to an embodiment.

FIG. 10 is a first perspective view showing a transmission mechanism according to an embodiment.

FIG. 11 is a second perspective view showing a transmission mechanism according to an embodiment.

FIG. 12 is a cross-sectional view showing an insertion process of an electric actuator according to an embodiment.

### DESCRIPTION OF THE EMBODIMENTS

The following describes an electric actuator according to an embodiment of the invention with reference to the drawings. The scope of the invention is not limited to the following embodiments and can be arbitrarily modified within the scope of the technical concept of the invention. In the following drawings, the scale and the number of each structure may differ from the actual structure in order to make each configuration easier to understand.

In each figure, a first direction D1 indicated by an arrow D1 is the direction in which a protrusion part provided in a second housing protrudes. In the embodiment, the first direction D1 is the upper-lower direction of the electric actuator. In the following description, the side toward which the arrow of the first direction D1 points (+D1 side) is referred to as “one side in the first direction D1” or “upper side,” and the opposite side to which the arrow of the first direction D1 points (−D1 side) is referred to as “the other side in the first direction D1” or “lower side.”

In each figure, a second direction D2 indicated by an arrow D2 is the direction in which the motor axis extends. The second direction D2 is a direction that intersects with the first direction D1. In the embodiment, the second direction D2 is a direction orthogonal to the first direction D1. It may also be that the second direction D2 is not orthogonal to the first direction D1. In the embodiment, the second direction D2 is the left-right direction of the electric actuator. In the following description, the side toward which the arrow sign of the second direction D2 points (+D2 side) is referred to as “right side,” and the opposite side to which the arrow sign of the second direction D2 points (−D2 side) is referred to as “left side.”

In each figure, a third direction D3 indicated by an arrow sign D3 is a direction that intersects with both the first direction D1 and the second direction D2. In the embodiment, the third direction D3 is a direction orthogonal to both the first direction D1 and the second direction D2. It may also be that the third direction De is not orthogonal to the first direction D1. In the embodiment, the third direction D3 is the front-rear direction of the electric actuator. In the following description, the side toward which the arrow of the third direction D3 points (+D3 side) is referred to as “front side,” and the opposite side to which the arrow of the third direction D3 points (−D3 side) is referred to as “rear side.” The upper side, lower side, right side, left side, front side, and rear side are merely expressions to describe the relative positional relationship of each part, and the actual arrangement relationship may be an arrangement relationship other than the arrangement relationship indicated by the expressions.

As described above, the direction in which a motor axis J1 shown as appropriate in each figure extends is parallel to the second direction D2. The motor axis J1 is a virtual axis. In the following description, the radial direction centered on the motor axis J1 is simply referred to as “radial direction.” The circumferential direction centered on the motor axis J1 is simply referred to as “circumferential direction.” The circumferential direction is indicated as appropriate by an arrow θ1 in each figure.

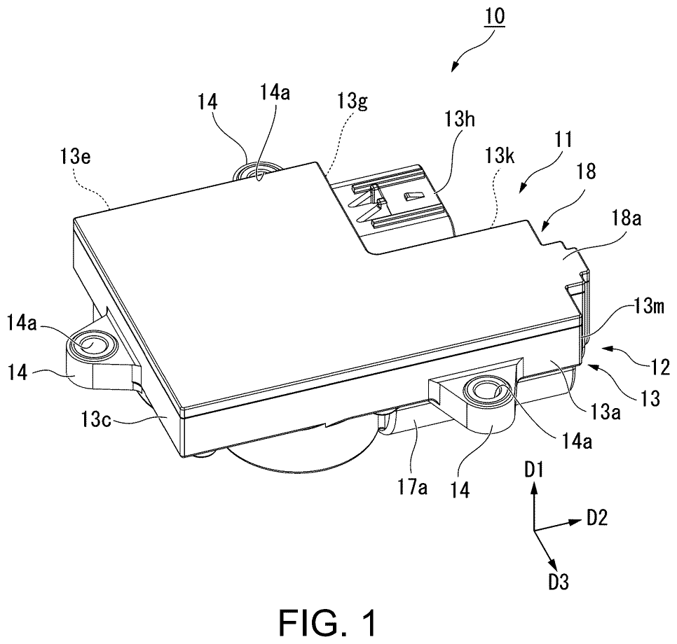

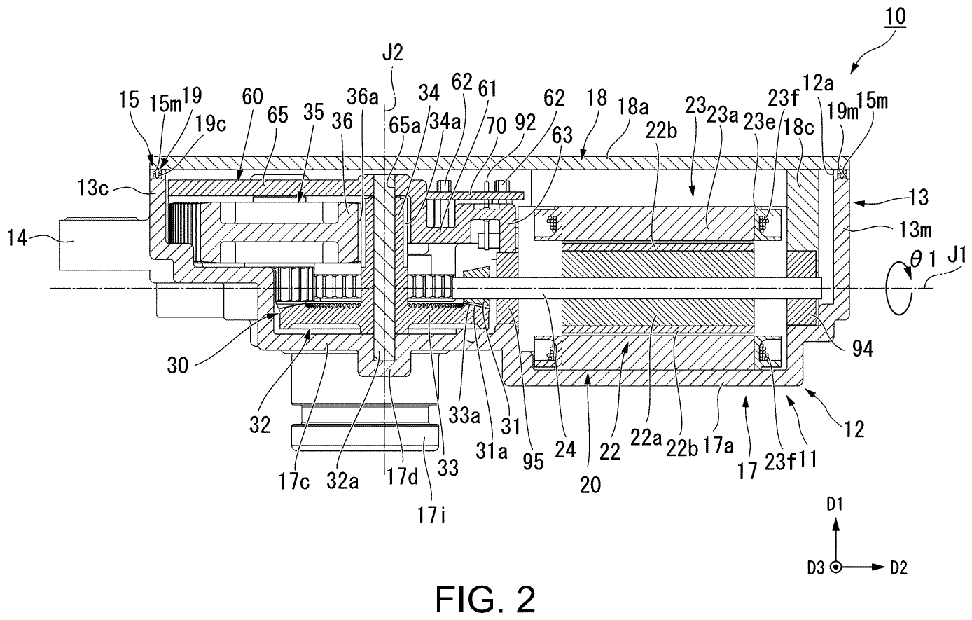

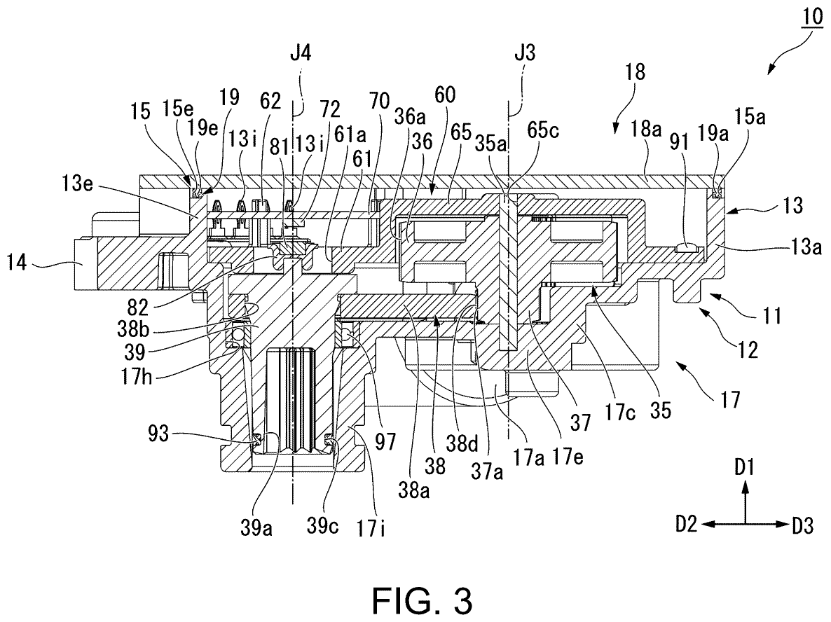

The electric actuator 10 of the embodiment shown in FIG. 1 is an electric actuator mounted in a vehicle. More specifically, the electric actuator 10 is mounted in an actuator device of a park-by-wire type that is driven based on a shift operation of the vehicle driver. As shown in FIG. 2, the electric actuator 10 includes a housing 11, a motor part 20, a transmission mechanism 30, and a cover member 60. As shown in FIG. 3, the electric actuator 10 includes an output shaft 39 and a substrate 70.

The housing 11 accommodates various parts of the electric actuator 10 such as the motor part 20, the transmission mechanism 30, the output shaft 39, and the substrate 70 therein. As shown in FIG. 1, the housing 11 is in a substantially L-shaped box shape when viewed from the first direction D1. The housing 11 possesses a first housing 12 and a second housing 18.

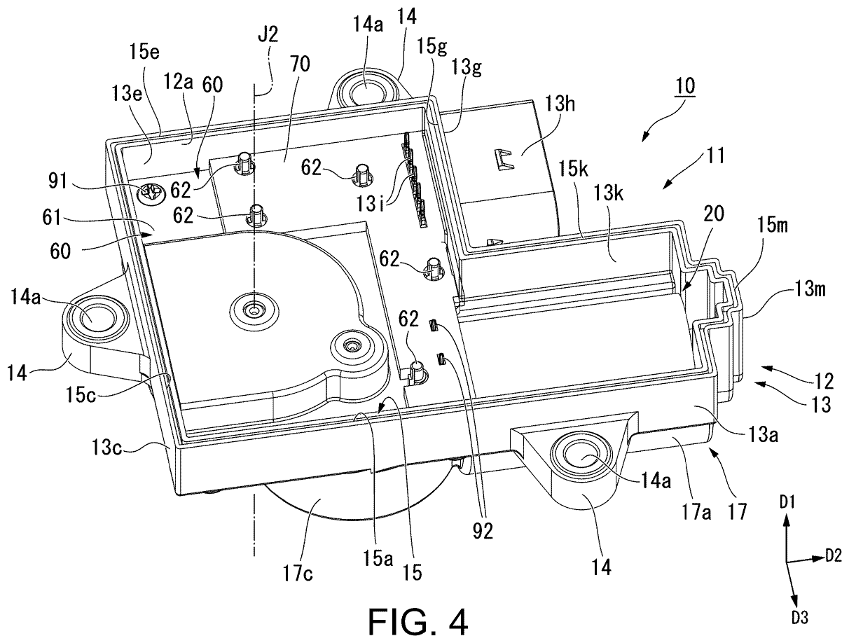

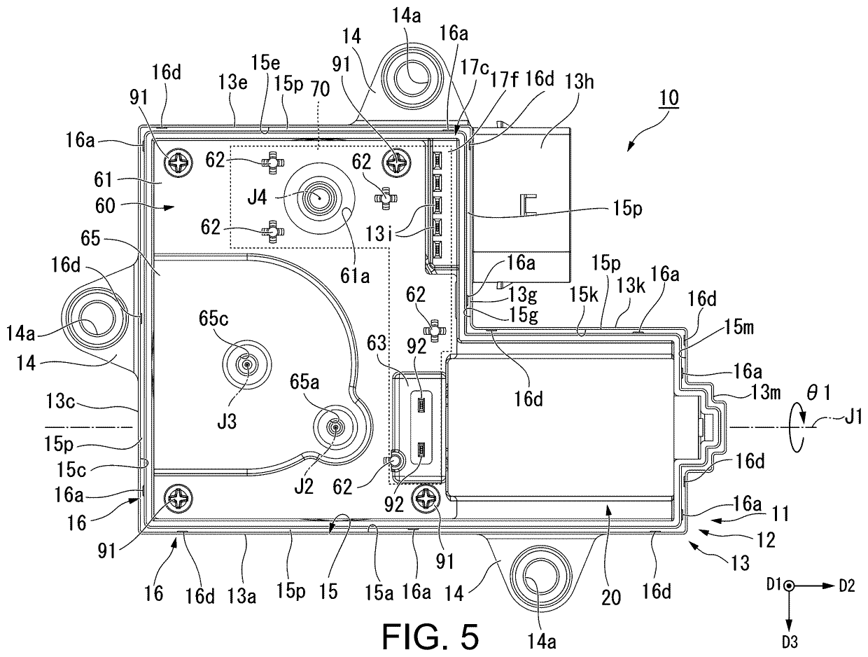

As shown in FIG. 4, when viewed from the first direction D1, the first housing 12 is in a substantially L-shaped box shape. The first housing 12 possesses an opening part 12a that opens to the upper side (+D1 side), that is, one side in the first direction D1. The first housing 12 possesses a side wall part 13, a mounting part 14, a groove part 15, and a bottom wall part 17. As shown in FIG. 5, the first housing 12 possesses a positioning part 16.

As shown in FIG. 2 and FIG. 3, the side wall part 13 surrounds various parts of the electric actuator 10, such as the motor part 20, the transmission mechanism 30, the output shaft 39, and the substrate 70, etc., from the outer side in the second direction D2 and the outer side in the third direction D3. As shown in FIG. 4, the side wall part 13 is tubular extending in the first direction D1. When viewed from the first direction D1, the side wall part 13 is substantially L-shaped. The side wall part 13 possesses a first side wall part 13a, a second side wall part 13c, a third side wall part 13e, a fourth side wall part 13g, a fifth side wall part 13k, and a sixth side wall part 13m.

The first side wall part 13a is a portion on the front side (+D3 side) of the side wall part 13. The first side wall part 13a is a plate shape extending in the second direction D2. The plate surface of the first side wall part 13a faces the third direction D3. When viewed from the third direction D3, the first side wall part 13a is substantially rectangular with the long side extending in the second direction D2.

The second side wall part 13c is a portion on the left side (−D2 side) of the side wall part 13. The second side wall part 13c is a plate shape extending toward the rear side (−D3 side) from the left end of the first side wall part 13a. The plate surface of the second side wall part 13c faces the second direction D2. When viewed from the second direction D2, the second side wall part 13c is substantially rectangular with the long side extending in the third direction D3.

The third side wall part 13e is a plate shape extending toward the right side (+D2 side) from the rear end (−D3 side) of the second side wall part 13c. The plate surface of the third side wall part 13e faces the third direction D3. When viewed from the third direction D3, the third side wall part 13e is substantially rectangular with the long side extending in the second direction D2. The dimension of the third side wall part 13e in the second direction D2 is smaller than the dimension of the first side wall part 13a in the second direction D2.

The fourth side wall part 13g is in a plate shape extending from the front side (+D3 side) from the right end (+D2 side) of the third side wall part 13e. The plate surface of the fourth side wall part 13g faces the second direction D2. When viewed from the second direction D2, the fourth side wall part 13g is substantially rectangular with the long side extending in the third direction D3. The dimension of the fourth side wall part 13g in the third direction D3 is smaller than the dimension of the second side wall part 13c in the third direction D3. A connector mounting part 13h is provided on the fourth side wall part 13g.

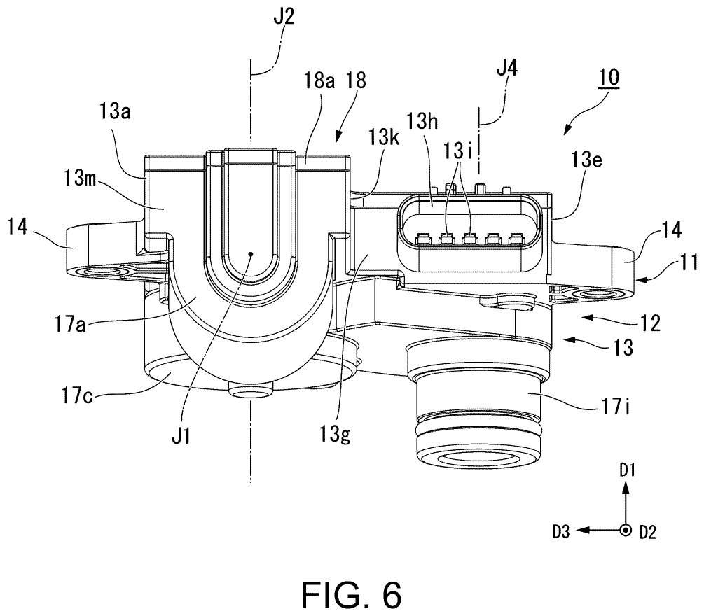

The connector mounting part 13h is substantially square tubular protruding toward the right side (+D2 side) from the fourth side wall part 13g. As shown in FIG. 6, the connector mounting part 13h opens to the right side. The interior of the connector mounting part 13h is connected to the interior of the housing 11 through a hole part (not shown) that penetrates the fourth side wall part 13g in the second direction D2. The connector mounting part 13h holds multiple connector pins 13i.

As shown in FIG. 4, the fifth side wall part 13k is in a plate shape extending toward the right side (+D2 side) from the front end (+D3 side) of the fourth side wall part 13g. The plate surface of the fifth side wall part 13k faces the third direction D3. When viewed from the third direction D3, the fifth side wall part 13k is substantially rectangular with the long side extending in the second direction D2. When viewed from the third direction D3, the right end of the fifth side wall part 13k overlaps the right end of the first side wall part 13a.

The sixth side wall part 13m is in a plate shape connecting the right end (+D 2 side) of the first side wall part 13a and the right end of the fifth side wall part 13k. The plate surface of the sixth side wall part 13m faces a direction orthogonal to the first direction D1. The central portion of the sixth side wall part 13m in the third direction D3 protrudes toward the right side in a rectangular shape.

The mounting part 14 protrudes toward the outer side from the side wall part 13. A mounting hole 14a that penetrates the mounting part 14 in the first direction D1 is provided in the mounting part 14. In the embodiment, the first housing 12 has three mounting parts 14. One of the mounting parts 14 protrudes toward the front side (+D3 side) from the first side wall part 13a. Another one of the mounting parts 14 protrudes toward the left side (−D2 side) from the second side wall part 13c. The other one of the mounting parts 14 protrudes toward the rear side (−D3 side) from the third side wall part 13e. When a bolt (not shown) passes through the mounting hole 14a of each mounting part 14 and is tightened into a female screw hole provided in a vehicle (not shown), the electric actuator 10 is fixed to the vehicle body.

The groove part 15 is a groove that is recessed toward the lower side (−D1 side), that is, toward the other side in the first direction D1, from the surface of the side wall part 13 facing the upper side (+D1 side). The groove part 15 is annular surrounding the opening part 12a. When viewed from the first direction D1, the groove part 15 is substantially L-shaped. As shown in FIG. 5, the groove part 15 includes a first groove part 15a, a second groove part 15c, a third groove part 15e, a fourth groove part 15g, a fifth groove part 15k, a sixth groove part 15m, and a linear part 15p.

The first groove part 15a is a groove provided on a surface of the first side wall part 13a facing the upper side (+D1 side). The first groove part 15a extends linearly in the second direction D2. The second groove part 15c is a groove provided on a surface of the second side wall part 13c facing the upper side. The second groove part 15c extends linearly in the third direction D3. The front end (+D3 side) of the second groove part 15c is connected with the left end (−D2 side) of the first groove part 15a. The third groove part 15e is a groove provided on a surface of the third side wall part 13e facing the upper side. The third groove part 15e extends linearly in the second direction D2. The left end of the third groove part 15e is connected with the rear end (−D3 side) of the second groove part 15c.

The fourth groove part 15g is a groove provided on a surface of the fourth side wall part 13g facing the upper side. The fourth groove part 15g extends linearly in the third direction D3. The rear end (−D3 side) of the fourth groove part 15g is connected with the right end (+D2 side) of the third groove part 15e. The fifth groove part 15k is a groove provided on a surface of the fifth side wall part 13k facing the upper side. The fifth groove part 15k extends linearly in the second direction D2. The left end (−D2 side) of the fifth groove part 15k is connected with the front end (+D3 side) of the fourth groove part 15g. The sixth groove part 15m is a groove provided on the surface of the sixth side wall part 13m facing the upper side. The sixth groove part 15 m connects the first groove part 15a and the fifth groove part 15k. The central portion of the sixth groove part 15m in the third direction D3 protrudes toward the right side in a rectangular shape.

The linear part 15p is a portion of the groove part 15 that extends linearly when viewed from the first direction D1. The groove part 15 includes multiple linear parts 15p. In the embodiment, the groove part 15 includes five linear parts 15p. The multiple linear parts 15p include the first groove part 15a, the second groove part 15c, the third groove part 15e, the fourth groove part 15g, and the fifth groove part 15k.

In the following description, the direction in which the groove part 15 extends refers to the direction in which each of the groove parts 15a, 15c, 15e, 15g, 15k, 15m that form the groove part 15 extends. Specifically, the direction in which the groove part 15 extends is the second direction D2 for the first groove part 15a, the third groove part 15e, and the fifth groove part 15k; the third direction D3 for the second groove part 15c and the fourth groove part 15g; and, for the sixth groove part 15m, the direction in which each part forming the sixth groove part 15m extends. Also, in the following description, for the first groove part 15a, the third groove part 15e, and the fifth groove part 15k, viewing from the direction in which the groove part 15 extends means viewing from the second direction D2; for the second groove part 15c and the fourth groove part 15g, viewing from the direction in which the groove part 15 extends viewing from the third direction D3; and for the sixth groove part 15m, viewing from the direction in which the groove part 15 extends means viewing from the direction in which each portion forming the sixth groove part 15m extends. Furthermore, in the following description, the center of the groove part 15 refers to the center of the groove part 15 in the direction orthogonal to the first direction D1 when viewed from the direction in which the groove part 15 extends.

The positioning part 16 is a protrusion that protrudes in the second direction D2 or the third direction D3 from a surface orthogonal to the first direction D1 among the inner surface of the groove part 15. That is, the positioning part 16 protrudes in a direction intersecting the first direction D1 from the inner surface of the groove part 15. In the embodiment, the first housing 12 includes multiple positioning parts 16. The respective positioning parts 16 are arranged at intervals along the direction in which the groove part 15 extends. The positioning parts 16 include multiple first positioning parts 16a and multiple second positioning parts 16d. Each of the first positioning parts 16a protrudes from a surface facing a side opposite to the side of the opening part 12a in the inner surface of the groove part 15 toward a side opposite to the side of the opening part 12a. Each of the second positioning parts 16d protrudes from a surface facing the side of the opening part 12a in the inner surface of the groove part 15 toward the side of the opening part 12a. The detailed configuration of the positioning part 16 will be described in detail later.

As shown in FIG. 2, the bottom wall part 17 is arranged on the lower side (−D1 side) of the motor part 20 and the transmission mechanism 30. Although not shown, when viewed from the first direction D1, the bottom wall part 17 is substantially L-shaped. The outer edge of the bottom wall part 17 is connected with the lower end of the side wall part 13 in the first direction D1. The bottom wall part 17 includes a motor housing part 17a and a transmission mechanism housing part 17c.

As shown in FIG. 6, the motor housing part 17a is semi-cylindrical extending in the second direction D2 with the motor axis J1 as the center. The motor housing part 17a protrudes on the lower side (-D1 side). As shown in FIG. 2, the motor housing part 17a is a portion on the right side (+D2 side) of the bottom wall part 17. The lower portion of the motor part 20 is accommodated inside the motor housing part 17a.

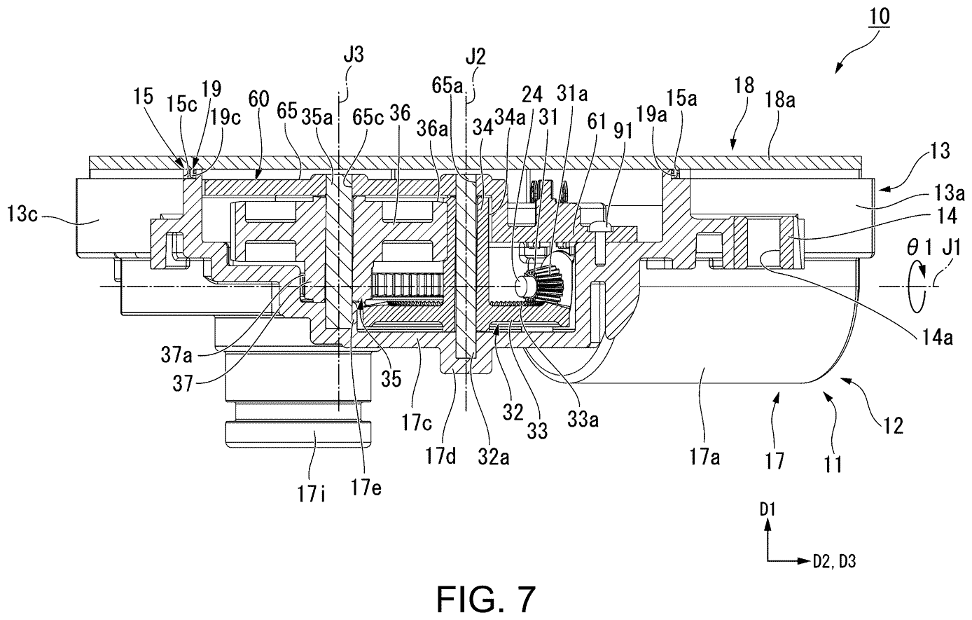

As shown in FIG. 3, the transmission mechanism housing part 17c is tubular protruding on the lower side (−D1 side). As shown in FIG. 2, the transmission mechanism housing part 17c is a portion on the left side (−D2 side) of the bottom wall part 17. A portion on the lower side of the transmission mechanism 30 is accommodated inside the transmission mechanism housing part 17c. As shown in FIG. 7, a first support part 17d and a second support part 17e are provided in the transmission mechanism housing part 17c. As shown in FIG. 5, a pin holding part 17f is provided in the transmission mechanism housing part 17c. As shown in FIG. 3, a bottom wall hole part 17h and a tubular part 17i are provided in the transmission mechanism housing part 17c.

As shown in FIG. 2, the first support part 17d protrudes on the lower side (−D1 side). The first support part 17d is substantially cylindrical with the first axis J2 as the center. The first support part 17d opens on the upper side (+D1 side). The first support part 17d is provided in a portion on the front side (+D3 side) of the transmission mechanism housing part 17c. The first axis J2 shown as appropriate in each figure is a virtual axis extending in the first direction D1. The first axis J2 intersects with the motor axis J1. In the embodiment, the first axis J2 is orthogonal to the motor axis J1. In the following description, the radial direction centered on the first axis J2 is simply referred to as “first radial direction”.

As shown in FIG. 7, the second support part 17e protrudes on the lower side (−D1 side). The second support part 17e is substantially cylindrical with the second axis J3 as the center. The second support part 17d opens on the upper side (+D1 side). The second support part 17e is provided on the rear side (−D3 side) and the left side (−D2 side) relative to the first support part 17d. Th second axis J3 shown as appropriate in each figure is a virtual axis extending in the first direction D1. In the following description, the radial direction centered on the second axis J3 is simply referred to as “second radial direction”.

As shown in FIG. 5, the pin holding part 17f is substantially rectangular parallelepiped protruding upward (+D1 side) from the bottom wall part 17. The pin holding part 17f is disposed on the left side (−D2 side) relative to the fourth side wall part 13g. The pin holding part 17f is connected with the fourth side wall part 13g. Multiple connector pins 13i pass through the inside of the pin holding part 17f. The pin holding parts 17f hold the respective connector pins 13i. Each of the connector pins 13i protrudes toward the upper side from the pin holding part 17f. As shown in FIG. 4, each of the connector pins 13i is connected to the substrate 70.

As shown in FIG. 3, the bottom wall hole part 17h is a hole that penetrates the transmission mechanism housing part 17c in the first direction D1. When viewed from the first direction D1, the bottom wall hole part 17h is substantially circular with an output axis J4 as the center. A third bearing 97 is fixed to the inner circumferential surface of the bottom wall hole part 17h. The third bearing 97 is substantially annular with the output axis J4 as the center. In the embodiment, the third bearing 97 is a ball bearing. The third bearing 97 may be a rolling bearing other than a ball bearing, or may be a sliding bearing. The output axis J4 shown as appropriate in each figure is a virtual axis extending in the first direction D1. In the following description, the radial direction centered on the output axis J4 is simply referred to as “output radial direction”.

The tubular part 17i protrudes toward the lower side (−D1 side) from an edge part of the bottom wall hole part 17h. The tubular part 17i is substantially cylindrical with the output axis J4 as the center. A portion on the lower side of the output shaft 39 is disposed inside the tubular part 17i.

As shown in FIG. 2, the second housing 18 is fixed to the upper end of the first housing 12. The second housing 18 blocks the opening part 12a of the first housing 12 from the upper side (+D1 side). The second housing 18 includes a cover part 18a, a protrusion support part 18c, and a protrusion part 19.

As shown in FIG. 1, the cover part 18a is in a plate shape extending in a direction orthogonal to the first direction D1. The plate surface of the cover part 18a faces the first direction D1. When viewed from the first direction D1, the cover part 18a is substantially L-shaped. When viewed from the first direction D1, the outer edge of the cover part 18a overlaps the side wall part 13. As shown in FIG. 2, the cover part 18a blocks the opening part 12a from the upper side (+D1 side). The cover part 18a contacts in the first direction D1 with the surface of the side wall part 13 facing the upper side. The cover part 18a blocks the groove part 15 from the upper side.

The protrusion support part 18c is columnar protruding toward the lower side (−D1 side) from the right end (+D2 side) of the cover part 18a. The protrusion support part 18c is opposite to the sixth side wall part 13m with a gap in the second direction D2.

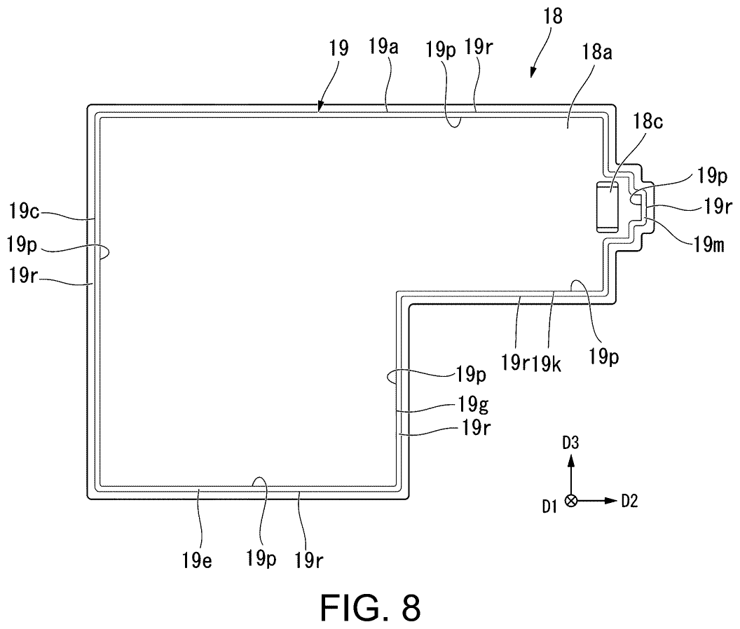

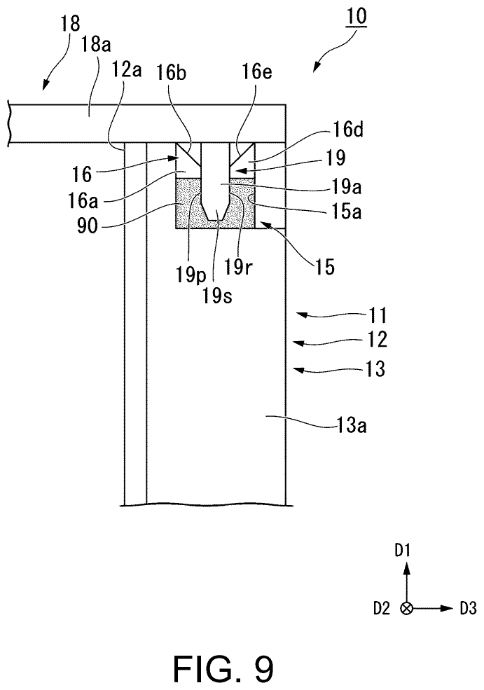

The protrusion part 19 protrudes toward the lower side (−D1 side), that is, the other side in the first direction D1, from the cover part 18a. As shown in FIG. 8, the protrusion part 19 is annular extending in a direction orthogonal to the first direction D1 along an edge part of the cover part 18a. Although not shown, the entire protrusion part 19 is disposed inside the groove part 15. The protrusion part 19 includes a first protrusion part 19a, a second protrusion part 19c, a third protrusion part 19e, a fourth protrusion part 19g, a fifth protrusion part 19k, and a sixth protrusion part 19m. As shown in FIG. 9, the protrusion part 19 includes a first surface 19 p, a second surface 19r, and a tip part 19s.

As shown in FIG. 8, the first protrusion part 19a is a portion on the front side (+D3 side) of the protrusion part 19. The first protrusion part 19a is in a plate shape extending in the second direction D2. The plate surface of the first protrusion part 19a faces the third direction D3. As shown in FIG. 9, the first protrusion part 19a is disposed inside the first groove part 15a.

As shown in FIG. 8, the second protrusion part 19c is a portion on the left side (−D2 side) of the protrusion part 19. The second protrusion part 19c is in a plate shape extending toward the rear side (−D3 side) from the left end of the first protrusion part 19a. The plate surface of the second protrusion part 19c faces the second direction D2. Although not shown, the second protrusion part 19c is disposed inside the second groove part 15c.

The third protrusion part 19e is in a plate shape extending toward the right side (+D2 side) from the rear end (−D3 side) of the second protrusion part 19c. The plate surface of the third protrusion part 19e faces the third direction D3. The dimension of the third protrusion part 19e in the second direction D2 is smaller than the dimension of the first protrusion part 19a in the second direction D2. As shown in FIG. 3, the third protrusion part 19e is disposed inside the third groove part 15e.

As shown in FIG. 8, the fourth protrusion part 19g is in a plate shape extending toward the front side (+D3 side) from the right end (+D2 side) of the third protrusion part 19e. The plate surface of the fourth protrusion part 19g faces the second direction D2. The dimension of the fourth protrusion part 19g in the third direction D3 is smaller than the dimension of the second protrusion part 19c in the third direction D3. Although not shown, the fourth protrusion part 19g is disposed inside the fourth groove part 15g.

The fifth protrusion part 19k is in a plate shape extending toward the right side (+D2 side) from the front end (+D3 side) of the fourth protrusion part 19g. The plate surface of the fifth protrusion part 19k faces the third direction D3. Although not shown, the fifth protrusion part 19k is positioned inside the fifth groove part 15k.

The sixth protrusion part 19m is in a plate shape connecting the right end (+D2 side) of the first protrusion part 19a and the right end of the fifth protrusion part 19k. The plate surface of the sixth protrusion part 19m faces a direction orthogonal to the first direction D1. The central portion of the sixth protrusion part 19m in the third direction D3 protrudes toward the right side in a rectangular shape. As shown in FIG. 2, the sixth protrusion part 19m is positioned inside the sixth groove part 15m.

As shown in FIG. 9, the first surface 19p is a surface of the outer surface of the protrusion part 19 that faces the side of the opening part 12a. The first surface 19p faces a direction orthogonal to the first direction D1. As described above, the protrusion part 19 is disposed inside the groove part 15. Also, as described above, the groove part 15 surrounds the opening part 12a. Therefore, as shown in FIG. 8, when viewed from the first direction D1, the first surface 19p possessed by each of the first protrusion part 19a, the second protrusion part 19c, the third protrusion part 19e, the fourth protrusion part 19 g, the fifth protrusion part 19 k, and the sixth protrusion part 19m of the protrusion part 19 faces the inner side of the second housing 18.

As shown in FIG. 9, the second surface 19r is a surface of the outer face of the protrusion part 19 that faces the side opposite to the side of the opening part 12a. The second surface 19r faces the side opposite to the first surface 19p. The second surface 19r faces a direction orthogonal to the first direction D1. As shown in FIG. 8, when viewed from the first direction D1, the second surface 19r possessed by each of the first protrusion part 19a, the second protrusion part 19c, the third protrusion part 19e, the fourth protrusion part 19g, the fifth protrusion part 19k, and the sixth protrusion part 19m of the protrusion part 19 faces the outer side of the second housing 18.

As shown in FIG. 9, the tip part 19s is a portion on the lower side (−D1 side), that is, the other side in the first direction D1, of the protrusion part 19. The tip part 19s is positioned on a lower side relative to the positioning part 16. The lower end of the tip part 19s is the lower end of the protrusion part 19. The dimension of the tip part 19s in a direction orthogonal to the direction in which the protrusion part 19 extends becomes smaller toward the lower side. More specifically, a portion of the outer surface of the tip part 19s in the first surface 19p is positioned on the opposite side of the side of the opening part 12a as the portion extends toward the lower side. A portion of the outer surface of the tip part 19s in the second surface 19r is positioned on the side of the opening part 12a as the portion extends toward the lower side.

The portion of the protrusion part 19 on the lower side (−D1 side) relative to the positioning part 16 is fixed to the inner surface of the groove part 15 by an adhesive 90. As a result, the protrusion part 19 is fixed to the inner surface of the groove part 15 by the adhesive 90. Therefore, the second housing 18 is fixed to the first housing 12. As the adhesive 90, for example, an adhesive having thermosetting properties, such as an epoxy resin adhesive, a melamine resin adhesive, a phenol resin adhesive, and an adhesive mixing these adhesives can be used. In this embodiment, the adhesive 90 is an epoxy resin adhesive.

As shown in FIG. 2, the cover member 60 is arranged on the upper side (+D1 side) relative to the transmission mechanism 30. The cover member 60 covers the transmission mechanism 30 from above. The cover member 60 includes a cover body part 61 and a convex part 65. As shown in FIG. 5, the cover body part 61 is in a plate shape and extends in a direction orthogonal to the first direction D1. The plate surface of the cover body part 61 faces the first direction D1. The cover body part 61 is fixed to the bottom wall part 17 by four screws 91. As a result, the cover member 60 is fixed to the second housing 18. The cover body part 61 is provided with a first hole part 61a, a substrate holding part 62, and a terminal holding part 63.

As shown in FIG. 3, the first hole part 61a is a hole that penetrates the cover body part 61 in the first direction D1. When viewed from the first direction D1, the first hole part 61a is substantially circular with the output axis J4 as the center. As shown in FIG. 2, the substrate holding part 62 is columnar and protrudes toward the upper side (+D1 side) from the cover body part 61. As shown in FIG. 5, five substrate holding parts 62 are provided on the cover body part 61. Each of the substrate holding parts 62 holds the substrate 70.

As shown in FIG. 2, the terminal holding part 63 protrudes toward the upper side (+D1 side) from the cover body part 61. As shown in FIG. 5, when viewed from the first direction D1, the terminal holding part 63 is substantially rectangular with the long side extending in the third direction D3. The terminal holding part 63 is disposed on the left side (−D2 side) relative to the motor part 20. The terminal holding part 63 is arranged in parallel with the motor part 20 in the second direction D2. The terminal holding part 63 holds two connection terminals 92. Each of the connection terminals 92 protrudes toward the upper side from the terminal holding part 63.

As shown in FIG. 3, the convex part 65 is tubular and protrudes toward the upper side (+D1 side) from the cover body part 61. The convex part 65 has an opening on the lower side (−D1 side). As shown in FIG. 5, when viewed from the first direction D1, the convex part 65 is substantially semicircular with an arc part protruding toward the right side (+D2 side). The convex part 65 is provided with a second hole part 65a and a third hole part 65c.

As shown in FIG. 7, each of the second hole part 65a and the third hole part 65c is a hole that penetrates the convex part 65 in the first direction D1. When viewed from the first direction D1, the second hole part 65a is substantially circular with the first axis J2 as the center. As shown in FIG. 5, the second hole part 65a is provided on the left side (−D2 side) relative to the motor part 20. As shown in FIG. 7, when viewed from the first direction D1, the second hole part 65a overlaps the first support part 17d. When viewed from the first direction D1, the third hole part 65c is substantially circular with the second axis J3 as the center. As shown in FIG. 5, the third hole part 65c is provided on the rear side (−D3 side) and the left side relative to the second hole part 65a. As shown in FIG. 7, when viewed from the first direction D1, the third hole part 65c overlaps the second support part 17e.

As shown in FIG. 2, the motor part 20 is accommodated in a portion of the right side (+D2 side) inside the housing 11. As described above, a portion on the lower side (−D1 side) of the motor part 20 is accommodated inside the motor housing part 17a. The motor part 20 includes a rotor 22 and a stator 23.

The rotor 22 is capable of rotating with the motor axis J1 as the center. The rotor 22 includes a rotor core 22a, multiple motor magnets 22b, and a motor shaft 24. The rotor core 22a is substantially annular with the motor axis J1 as the center. Each of the motor magnets 22b is fixed to the outer circumferential surface of the rotor core 22a. Each of the motor magnets 22b is arranged along the outer circumferential surface of the rotor core 22a.

The motor shaft 24 is substantially columnar extending in the second direction D2 with the motor axis J1 as the center. The rotor core 22a is fixed to the outer circumferential surface of the motor shaft 24. The left end (−D2 side) of the motor shaft 24 is positioned inside the transmission mechanism housing part 17c. The right end (+D2 side) of the motor shaft 24 is rotatably supported around the motor axis J1 by the first bearing 94. A portion on the left side of the motor shaft 24 is rotatably supported around the motor axis J1 by the second bearing 95. Accordingly, the motor shaft 24 is capable of rotating with the motor axis J1 as the center. In the embodiment, the first bearing 94 and the second bearing 95 are sliding bearings. The first bearing 94 and the second bearing 95 may be ball bearings. The first bearing 94 is held by the protrusion support part 18c and the bottom wall part 17. The second bearing 95 is held by the terminal holding part 63 and the bottom wall part 17.

The stator 23 is arranged on the radial outer side of the rotor 22. The stator 23 is disposed facing the rotor 22 with a gap in the radial direction. The stator 23 includes a stator core 23a, an insulator 23e, and multiple coil parts 23f. The stator core 23a is substantially annular with the motor axis J1 as the center. The stator core 23a surrounds the rotor 22 from the radial outer side. A portion on the lower side (−D1 side) of the outer circumferential surface of the stator core 23a is fixed to the inner surface of the motor housing part 17a. Accordingly, the stator 23 is fixed to the housing 11.

The insulator 23e insulates the stator core 23a and each coil part 23f. In the embodiment, the insulator 23e is made of resin. The insulator 23e is mounted on the stator core 23a. Each coil part 23f is mounted on the stator core 23a via the insulator 23e. Each coil part 23f is disposed along the circumferential direction. Although not shown, each coil part 23f is electrically connected to the connection terminal 92.

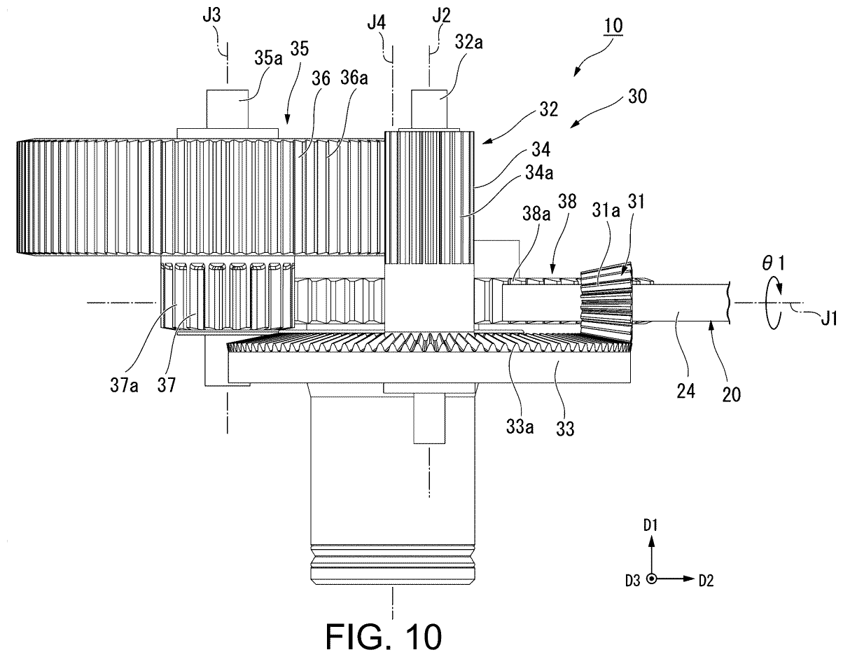

The transmission mechanism 30 is arranged on the left side (−D2 side) relative to the motor part 20. As described above, a portion on the lower side (−D1 side) of the transmission mechanism 30 is accommodated inside the transmission mechanism housing part 17c. The transmission mechanism 30 is covered from the upper side (+D1 side) by the cover member 60. The transmission mechanism 30 is connected to the motor shaft 24. As shown in FIG. 3, the transmission mechanism 30 is connected to the output shaft 39. That is, the transmission mechanism 30 is connected to both the motor shaft 24 and the output shaft 39. The transmission mechanism 30 transmits the rotation of the motor shaft 24 to the output shaft 39. In the embodiment, the transmission mechanism 30 decelerates and transmits the rotation of the motor shaft 24 to the output shaft 39. The transmission mechanism 30 may accelerate and transmit the rotation of the motor shaft 24 to the output shaft 39, or may transmit rotation at the same rotational speed as the motor shaft 24 to the output shaft 39. As shown in FIG. 10, the transmission mechanism 30 includes a first gear 31, a first stage gear 32, a second stage gear 35, and an output gear 38. The rotation of the motor shaft 24 is transmitted in the order of the first gear 31, the first stage gear 32, the second stage gear 35, the output gear 38, and the output shaft 39.

The first gear 31 transmits the rotation of the motor shaft 24 to the second stage gear 35. The first gear 31 is substantially columnar extending in the second direction D2. Inside the first gear 31, the motor shaft 24 passes through. The inner circumferential surface of the first gear 31 is fixed to the outer circumferential surface of the motor shaft 24. Accordingly, the transmission mechanism 30 is connected to the motor shaft 24. The first gear 31 is rotatable around the motor axis J1 together with the motor shaft 24. In the embodiment, the first gear 31 is a bevel gear. The outer diameter of the first gear 31 decreases toward the left side (−D2 side). On the outer circumferential surface of the first gear 31, a first gear part 31a is provided.

The first stage gear 32 transmits the rotation of the first gear 31 to the second stage gear 35. As shown in FIG. 2, the first stage gear 32 is substantially cylindrical with the first axis J2 as the center. Inside the first stage gear 32, a first shaft part 32a passes through in the first direction D1. The upper end of the first shaft part 32a is supported by the inner circumferential surface of the second hole part 65a. The lower end of the first shaft part 32a is supported by the inner circumferential surface of the first support part 17d. The first stage gear 32 is rotatably supported around the first axis J2 by the first shaft part 32a. The first stage gear 32 includes a first large-diameter gear 33 and a first small-diameter gear 34.

The first large-diameter gear 33 is in a substantially annular plate-shape, with the first axis J2 as the center. The first large-diameter gear 33 is rotatable around the first axis J2. As shown in FIG. 10, the first large-diameter gear 33 is a bevel gear. The outer diameter of the first large-diameter gear 33 becomes smaller toward the upper side (+D1 side). On the surface of the first large-diameter gear 33 facing the upper side, a first large-diameter gear part 33a that meshes with the first gear part 31a is provided. The number of teeth of the first large-diameter gear part 33a is greater than the number of teeth of the first gear part 31a. Accordingly, the rotation of the motor shaft 24 and the first gear 31 is decelerated and transmitted to the first stage gear 32.

The first small-diameter gear 34 is substantially annular with the first axis J2 as the center. The first small-diameter gear 34 is disposed on the upper side (+D1 side) relative to the first large-diameter gear 33. The first small-diameter gear 34 is connected to the first large-diameter gear 33 in the first direction D1. The first small-diameter gear 34 is rotatable around the first axis J2 together with the first large-diameter gear 33. On the surface of the first small-diameter gear 34 facing the outer side in the first radial direction, a first small-diameter gear part 34a is provided.

The second stage gear 35 transmits the rotation of the first stage gear 32 to the output gear 38. The second stage gear 35 is substantially annular with the second axis J3 as the center. As shown in FIG. 7, inside the second stage gear 35, a second shaft part 35a passes through in the axial direction. The upper end of the second shaft part 35a is supported by the inner circumferential surface of the third hole part 65c. The lower end of the second shaft part 35a is supported by the inner circumferential surface of the second support part 17e. The second stage gear 35 is rotatably supported around the second axis J3 by the second shaft part 35a. The second stage gear 35 includes a second large-diameter gear 36 and a second small-diameter gear 37.

The second large-diameter gear 36 is substantially annular with the second axis J3 as the center. The second large-diameter gear 36 is rotatable around the second axis J3. As shown in FIG. 10, on the surface of the second large-diameter gear 36 facing the outer side in the second radial direction, a second large-diameter gear part 36a that meshes with the first small-diameter gear part 34a is provided. The number of teeth of the second large-diameter gear part 36a is greater than the number of teeth of the first small-diameter gear part 34a. Accordingly, the rotation of the first stage gear 32 is decelerated and transmitted to the second stage gear 35.

The second small-diameter gear 37 is substantially annular with the second axis J3 as the center. The second small-diameter gear 37 is disposed on a lower side (−D1 side) relative to the second large-diameter gear 36. The second small-diameter gear 37 is connected to the second large-diameter gear 36 in the first direction D1. The second small-diameter gear 37 is rotatable around the second axis J3 together with the second large-diameter gear 36. On the surface of the second small-diameter gear 37 facing the radial outer side in the second radial direction, a second small-diameter gear part 37a is provided.

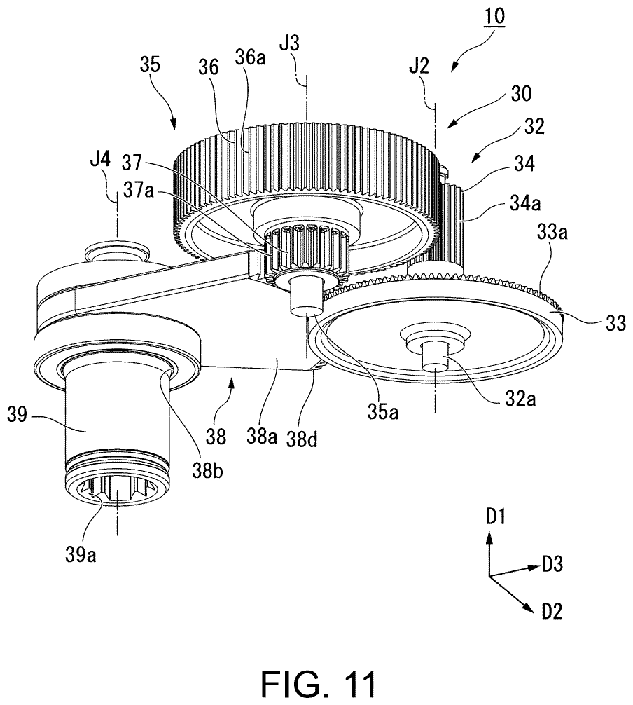

As shown in FIG. 11, the output gear 38 transmits the rotation of the second stage gear 35 to the output shaft 39. The output gear 38 is rotatable around the output axis J4. The output gear 38 includes an output gear body part 38a and an output gear part 38d. The output gear body part 38a is a substantially fan-shaped plate with the output axis J4 as the center. The plate surface of the output gear body part 38a faces the first direction D1. As shown in FIG. 3, a hole part 38b is provided in the output gear body part 38a. The hole part 38b is a hole that penetrates the output gear body part 38a in the first direction D1. When viewed from the first direction D1, the hole part 38b is substantially circular with the output axis J4 as the center. Inside the hole part 38b, the output shaft 39 passes through in the first direction D1. The inner circumferential surface of the hole part 38b is fixed to the outer circumferential surface of the output shaft 39. Accordingly, the transmission mechanism 30 is connected to the output shaft 39.

As shown in FIG. 11, the output gear part 38d is provided on a portion of the outer circumferential surface of the output gear body part 38a that forms an arc of the output gear body part 38a. The output gear part 38d extends in an arc with the output axis J4 as the center. The output gear part 38d meshes with the second small-diameter gear part 37a. Accordingly, the rotation of the second stage gear 35 is transmitted to the output gear 38. In the embodiment, the rotation of the second stage gear 35 is decelerated and transmitted to the output gear 38.

As shown in FIG. 3, the output shaft 39 is substantially columnar extending in the first direction D1, with the output axis J4 as the center. The rotation of the motor shaft 24 is decelerated and transmitted to the output shaft 39 through the transmission mechanism 30. As described above, the output shaft 39 is fixed to the inner circumferential surface of the hole part 38b. The upper end of the output shaft 39 is positioned inside the first hole part 61a of the cover member 60. A portion of the outer circumferential surface of the output shaft 39 on the lower side (−D1 side) relative to the output gear 38 is rotatably supported around the output axis J4 by the third bearing 97. The lower end of the output shaft 39 is positioned inside the tubular part 17i. The output shaft 39 is provided with a link concave part 39a and a shaft concave part 39c.

The link concave part 39a is recessed toward the upper side (+D1 side) from a surface of the output shaft 39 facing the lower side (−D1 side). A driven member (not shown) can be inserted from the lower side into the link concave part 39a. When multiple spline grooves provided on the outer circumferential surface of the driven member are fitted to multiple spline grooves provided on the inner circumferential surface of the link concave part 39a, the link concave part 39a and the driven member are connected to each other. In the embodiment, the driven member is, for example, a manual shaft of a vehicle. The electric actuator 10 drives the manual shaft based on the shift operation of the driver to switch the gear of the vehicle.

The shaft concave part 39c is a groove that is recessed to the inner side in the output radial direction from the outer circumferential surface of the output shaft 39. The shaft concave part 39c is provided in a portion on the lower side (−D1 side) of the output shaft 39. The shaft concave part 39c extends around the entire circumference along the outer circumferential surface of the output shaft 39. An O-ring 93 is fitted into the output shaft 39. The O-ring 93 contacts the inner circumferential surface of the tubular part 17 i. The O-ring 93 seals between the output shaft 39 and the housing 11.

The magnet 81 is fixed to the upper end of the output shaft 39 through the magnet holding part 82. Accordingly this, the magnet 81 is rotatable around the output axis J4 together with the output shaft 39. The magnet 81 faces the substrate 70 with a gap in the first direction D1.

The substrate 70 supplies current to the motor part 20. The substrate 70 controls the direct current supplied to the coil part 23f. As shown in FIG. 4, in the embodiment, the substrate 70 is a substantially L-shaped plate. The plate surface of the substrate 70 faces the first direction D1. As shown in FIG. 2 and FIG. 3, the substrate 70 is disposed on the upper side (+D1 side) relative to the transmission mechanism 30. As shown in FIG. 4, each substrate holding part 62 passes through the substrate 70 in the first direction D1. The substrate 70 is held by each substrate holding part 62. Accordingly, the substrate 70 is held by the cover member 60.

Each connector pin 13i passes through the substrate 70 in the first direction D1. The substrate 70 is connected to each connector pin 13i. Accordingly, the substrate 70 is electrically connected to an external power source (not shown) through each connector pin 13i. The substrate 70 generates current to be supplied to the coil part 23f by using the current supplied from the external power source. Furthermore, each connection terminal 92 passes through the substrate 70 in the first direction D1. The substrate 70 is connected to each connection terminal 92. As described above, each coil part 23f is electrically connected to the connection terminal 92. Accordingly, the substrate 70 is electrically connected to each coil part 23f through each connection terminal 92, and supplies current to the coil part 23f. In other words, the substrate 70 supplies current to the motor part 20. Accordingly, the substrate 70 drives the motor part 20. As shown in FIG. 3, a magnetic sensor 72 is mounted on a surface of the substrate 70 facing the lower side (−D1 side).

The magnetic sensor 72 faces the magnet 81 in the first direction D1. The magnetic sensor 72 is a magnetic sensor capable of detecting the magnetic field of the magnet 81. The magnetic sensor 72 is, for example, a magnetic sensor equipped with a Hall element, such as a Hall IC. When the magnet 81 rotates around the output axis J4 together with the output shaft 39, the magnetic sensor 72 detects changes in the magnetic field of the magnet 81. Accordingly, the magnetic sensor 72 detects the rotation of the motor shaft 24.

As described above, the first positioning part 16a shown in FIG. 9 protrudes from a surface facing the opposite side of the opening part 12a in the inner surface of the groove part 15 toward a side opposite to the side of the opening part 12a. Each first positioning part 16a faces the first surface 19p of the protrusion part 19. As described above, the second positioning part 16d protrudes from a surface facing the side of the opening part 12a in the inner surface of the groove part 15 toward the side of the opening part 12a. Each second positioning part 16d faces the second surface 19r of the protrusion part 19. Accordingly, the protrusion part 19 is disposed between the first positioning part 16a and the second positioning part 16d inside the groove part 15. Therefore, in the embodiment, the protrusion part 19 can be precisely disposed along the center of the groove part 15.

In the embodiment, at least one first positioning part 16a is in contact with the protrusion part 19. That is, at least one positioning part 16 is in contact with the protrusion part 19. Accordingly, compared to the case where the positioning part 16 does not contact the protrusion part 19, the protrusion part 19 can be more precisely disposed along the center of the groove part 15. It may also be that none of the first positioning parts 16a contact the protrusion part 19, and at least one second positioning part 16d may contact the protrusion part 19. In this case as well, compared to the case where the positioning part 16 does not contact the protrusion part 19, the protrusion part 19 can be more precisely disposed along the center of the groove part 15. In the embodiment, at least one first positioning part 16a and at least one second positioning part 16d are respectively in contact with the protrusion part 19. Accordingly, the protrusion part 19 can be more precisely arranged along the center of the groove part 15.

As shown in FIG. 5, one second positioning part 16d is disposed between first positioning parts 16a disposed in adjacency along the direction in which the groove part 15 extends. That is, the first positioning part 16a and the second positioning part 16d are provided alternately along the direction in which the groove part 15 extends. Also, each of the first groove part 15a, the second groove part 15c, the third groove part 15e, the fourth groove part 15g, and the fifth groove part 15k is provided with at least one first positioning part 16a and at least one second positioning part 16d. That is, each of multiple linear parts 15p is provided with the first positioning part 16a and the second positioning part 16d. In the embodiment, the first positioning part 16a and the second positioning part 16d are also provided in the sixth groove part 15m.

As shown in FIG. 9, a surface 16b of each first positioning part 16a facing the upper side (+D1 side) is positioned on a lower side (−D1 side) as the surface approaches the center of the groove part 15. That is, the surface 16b of each first positioning part 16a facing the upper side is an inclined surface that is positioned on the lower side as the surface approaches the protrusion part 19. A surface 16e of each second positioning part 16d facing the upper side is positioned on a lower side the surface approaches the center of the groove part 15. That is, the surface 16e of each second positioning part 16d facing the upper side is an inclined surface that is positioned on a lower side as the surface approaches the protrusion part 19. Accordingly, the surfaces of the respective positioning parts 16 facing the upper side, that is, facing one side in the first direction D1, are inclined surfaces positioned on the lower side, that is, on the other side in the first direction D1, as the surfaces approach the protrusion part 19.

Next, a fixing process Pf for fixing the second housing 18 to the first housing in the embodiment will be described. The fixing process Pf is a part of an assembly process of the electric actuator 10. The fixing process Pf includes: a filling process P1 for filling an uncured adhesive 90 throughout the entire circumference of the groove part 15; an insertion process P2 for inserting the protrusion part 19 into the groove part 15; and a curing process P3 for curing the adhesive 90 to fix the second housing 18 to the first housing. In the following description, “worker, etc. ,” includes a worker and an assembly device that perform the operation in each process. The operation in each process may be performed only by the worker, only by the assembly device, or by both the worker and the assembly device.

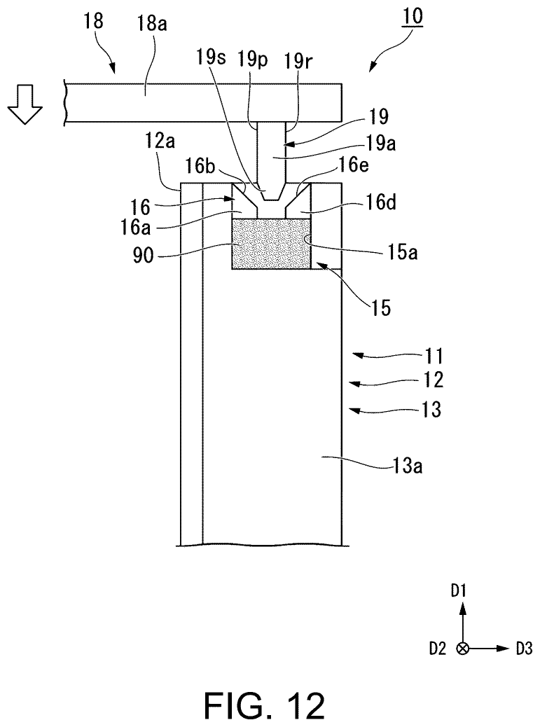

In the filling process P1, the uncured adhesive 90 is filled throughout the entire circumference of the groove part 15. The worker, etc., fills the uncured adhesive 90 into the groove part 15 of the first housing 12 to which the respective parts of the electric actuator 10 such as the motor part 20, the transmission mechanism 30, the output shaft 39, and the substrate 70 are mounted in advance as shown in FIG. 12. In the embodiment, the worker, etc., fills the uncured adhesive 90 into a portion of the groove part 15 on the lower side (−D1 side) relative to each positioning part 16. The worker, etc., may also fill the uncured adhesive 90 into a portion of the groove part 15 that is on the upper side (+D1 side) relative to each positioning part 16. Although not shown, the worker, etc., fills the uncured adhesive 90 throughout the entire circumference of the groove part 15. The filling process P1 is completed when the worker, etc., fills the adhesive 90 throughout the entire circumference of the groove part 15.

In the insertion process P2, the protrusion part 19 is inserted into the groove part 15. The worker, etc., inserts the protrusion part 19 into the groove part 15 by moving the second housing 18, which is disposed on the upper side (+D1 side) of the first housing 12, to the lower side (−D1 side). As described above, the surface 16b of each first positioning part 16a facing the upper side is an inclined surface that is positioned on the lower side as the surface approaches the center of the groove part 15. The surface 16e of each second positioning part 16d facing the upper side is an inclined surface that is positioned on the lower side as the surface approaches the center of the groove part 15. Therefore, in the insertion process P2, the surfaces 16b, 16e of each positioning part 16 facing the upper side can guide the protrusion part 19 to the center of the groove part 15. Accordingly, the protrusion part 19 can be easily inserted into the center of the groove part 15. Consequently, the protrusion part 19 can be precisely arranged along the center of the groove part 15. Also, as described above, the tip part 19s of the protrusion part 19 has a dimension that decreases in a direction orthogonal to the direction in which the protrusion part 19 extends as the tip part 19s approaches the other side. Therefore, in the insertion process P2, since the tip part 19s can be prevented from being caught on each positioning part 16, the protrusion part 19 can be easily inserted into the groove part 15. As shown in FIG. 9, the insertion process P2 is completed when the second housing 18 is moved toward the lower side until the cover part 18a contacts the surface of the side wall part 13 facing upward in the first direction D1. At this time, the tip side portion of the protrusion part 19 is positioned on the lower side relative to each positioning part 16. Also, the portion on the tip side of the protrusion part 19 is positioned inside the uncured adhesive 90.

In the curing process P3, the uncured adhesive 90 is cured to fix the second housing 18 to the first housing 12. The worker, etc., first presses the second housing 18 toward the lower side (−D1 side) relative to the first housing 12 by using a pressing jig (not shown). Accordingly, the state where the cover part 18a contacts the surface of the side wall part 13 facing the upper side (+D1 side) in the first direction D1. Next, the worker, etc., heats the first housing 12 against which the second housing 18 is pressed by using the pressing jig in a heating furnace. When the uncured adhesive 90 is cured, the protrusion part 19 is fixed to the inner surface of the groove part 15 by the adhesive 90. More specifically, a portion on the lower side (−D1 side) of the first surface 19p of the protrusion part and a portion on the lower side of the second surface 19r are each fixed to the inner surface of the groove part 15 by the adhesive 90. Also, the second housing 18 is fixed to the first housing 12 in a state where the cover part 18a contacts the surface of the side wall part 13 facing the upper side in the first direction D1. The curing process P3 is completed when the worker, etc., cures the uncured adhesive 90 to fix the second housing 18 to the first housing 12. When the curing process P3 is completed, the fixing process Pf is completed.

According to the embodiment, the first housing 12 includes: the annular groove part 15 that surrounds the opening part 12a and is recessed toward the lower side (−D1 side), namely to the other side in the first direction D1; and the positioning parts 16 that protrude from the inner surface of the groove part 15 in a direction intersecting the first direction D1. The second housing 18 includes the annular protrusion part 19 that protrudes toward the lower side and is disposed inside the groove part 15. The positioning parts 16 include: the first positioning parts 16a facing the first surface 19p that faces the side of the opening part 12a in the outer surface of the protrusion part 19; and the second positioning parts 16d that face the second surface 19r facing the side opposite to the first surface 19p in the outer surface of the protrusion part 19. The protrusion part 19 is fixed to the inner surface of the groove part 15 by the adhesive 90. Therefore, in the insertion process P2 of inserting the protrusion part 19 into the groove part 15 during the fixing process Pf of fixing the second housing 18 to the first housing 12, the protrusion part 19 can be easily disposed along the center of the groove part 15 by using each of the first positioning parts 16a and each of the second positioning parts 16d. As a result, in the curing process P3 of curing the uncured adhesive 90, the work of arranging the protrusion part 19 along the center of the groove part 15 by using a positioning jig that determines the position of the second housing 18 relative to the first housing 12 in a direction intersecting the first direction D1 is not required. Therefore, in the embodiment, since such positioning jig is not required, an increase in the equipment cost required for manufacturing the electric actuator 10 can be suppressed. Also, since the protrusion part 19 can be easily disposed along the center of the groove part 15, an increase in work man-hours for the fixing process Pf can be suppressed. Consequently, an increase in the manufacturing cost of the electric actuator 10 can be suppressed.

Also, in the embodiment, as described above, since such positioning jig is not required in the curing process P3, the number of electric actuators 10 that can be disposed inside the heating furnace can be increased. Accordingly, it is possible to increase the number of electric actuators 10 for which the uncured adhesive 90 can be cured in a single heating operation. Consequently, an increase in the manufacturing man-hours and manufacturing cost of the electric actuator 10 can be suppressed.

In addition, in the embodiment, as described above, since the protrusion part 19 can be arranged along the center of the groove part 15 by each positioning part 16, both the outer surfaces of the first surface 19p and the second surface 19r of the protrusion part 19 can be fixed to the inner surface of the groove part 15 by the adhesive 90. Therefore, since the adhesive area between the protrusion part 19 and the inner surface of the groove part 15 can be widened, the adhesive strength between the first housing 12 and the second housing 18 can be suitably enhanced. As a result, even if the vibration of the motor part 20 is transmitted to the second housing 18 during the operation of the electric actuator 10, the second housing 18 can be prevented from being detached from the first housing 12. Consequently, the entry of moisture and dust into the interior of the housing 11 can be suitably suppressed, so the operation of the electric actuator 10 can be suitably stabilized.

According to the embodiment, at least one of the positioning parts 16 is in contact with the protrusion part 19. As a result, as described above, the protrusion part 19 can be more precisely arranged along the center of the groove part 15 by the positioning parts 16. Therefore, since both outer surfaces of the first surface 19p and the second surface 19r of the protrusion part 19 can be more stably fixed to the inner surface of the groove part 15 by the adhesive 90, the adhesive strength between the first housing 12 and the second housing 18 can be more suitably enhanced.

According to the embodiment, at least one first positioning part 16a and at least one second positioning part 16d are respectively in contact with the protrusion part 19. Accordingly, compared to the case where none of the first positioning parts 16a contacts the protrusion part 19, or the case where none of the second positioning parts 16d contacts the protrusion part 19, the protrusion part 19 can be more precisely arranged along the center of the groove part 15. Consequently, the adhesive strength between the first housing 12 and the second housing 18 can be more suitably enhanced.

According to the embodiment, the first positioning parts 16a and the second positioning parts 16d are alternately provided along the direction in which the groove part 15 extends. Therefore, since the position of the protrusion part 19 relative to the groove part 15 can be determined alternately from the side of the opening part 12a and the opposite side of the side of the opening part 12a, the protrusion part 19 can be more precisely disposed along the center of the groove part 15. Consequently, the adhesive strength between the first housing 12 and the second housing 18 can be more suitably enhanced.

According to the embodiment, the groove part 15, when viewed from the first direction D1, has multiple linear parts 15p extending linearly, and the first positioning part 16a and the second positioning part 16d are provided at each of the linear parts 15p. Therefore, compared to the case where only one of the first positioning part 16a and the second positioning part 16d is provided at each of the linear parts 15p, the protrusion part 19 can be precisely arranged along the center of the groove part 15 in each of the linear parts 15p. Consequently, since the adhesive strength between each portion of the protrusion part 19 and the inner surface of the groove part 15 can be enhanced in each of the linear parts 15p, the adhesive strength between the first housing 12 and the second housing 18 can be more suitably enhanced.

According to the embodiment, the upper side (+D1 side) of each of the positioning parts 16, that is, the surfaces 16b, 16e facing one side in the first direction D1, are inclined surfaces positioned on the lower side (−D1 side), that is, the other side in the first direction D1, as the surfaces 16b, 16e approach the protrusion part 19. Therefore, as described above, in the insertion process P2, the surfaces 16b, 16e facing the upper side of each of the positioning parts 16 can guide the protrusion part 19 to the center of the groove part 15. Accordingly, the protrusion part 19 to be easily inserted along the center of the groove part 15, thereby suppressing an increase in work man-hours of the insertion process P2. Consequently, an increase in manufacturing man-hours of the electric actuator 10 can be more suitably suppressed.

According to the embodiment, the tip part 19s of the protrusion part 19, that is, a portion of the protrusion part 19 on the other side in the first direction D1, has a dimension in a direction orthogonal to the direction in which the protrusion part 19 extends that becomes smaller as the tip part 19s approaches the other side (−D1 side). Therefore, as described above, in the insertion process P2, since the tip part 19s can be prevented from being caught on each positioning part 16, the protrusion part 19 can be easily inserted into the groove part 15. Accordingly, the increase in work man-hours of the insertion process P2 can more suitably suppressed. Consequently, an increase in manufacturing man-hours of the electric actuator 10 can be more suitably suppressed.

According to the embodiment, the electric actuator 10 includes: the output shaft 39, capable of rotating with the output axis J4 as the center; the transmission mechanism 30, connected with the motor shaft 24 and the output shaft 39 and transmitting the rotation of the motor shaft to the output shaft 39; the substrate 70, supplying current to the motor part 20. The housing 11 accommodates the transmission mechanism 30 and the substrate 70 therein. Therefore, the transmission mechanism 30 can be disposed close to each of the motor part 20 and the output shaft 39. As a result, the configuration of the transmission mechanism 30 can be simplified. Additionally, the substrate 70 and the motor part 20 can be arranged close to each other. As a result, the configuration for electrically connecting the substrate 70 and the motor part 20 can be simplified. Accordingly, since the configuration of the electric actuator 10 can be simplified, it is possible to suppress an increase in manufacturing cost of the electric actuator 10.

The embodiments of the invention have been described above, but the configurations in the embodiments and the combinations are merely examples. Additions, omissions, substitutions, and other changes to the configurations are possible within the scope not departing from the spirit of the invention. Furthermore, the invention is not limited by the embodiments.

The configuration of the transmission mechanism is not limited to the embodiment. For example, the transmission mechanism may not have one of the first stage gear or the second stage gear. In the case where the transmission mechanism does not have the first stage gear, the rotation of the first gear can be transmitted to the output gear by connecting the second stage gear to the first gear and the output gear. In the case where the transmission mechanism does not have the second stage gear, the rotation of the first gear can be transmitted to the output gear by connecting the first stage gear to the first gear and the output gear. Additionally, the transmission mechanism may have other components such as an intermediate gear that transmits the rotation of the first stage gear to the second stage gear. In the case where the intermediate gear is a stage gear having multiple gear parts with different numbers of teeth, the degree of freedom for the setting range of the deceleration ratio of the rotation of the output shaft relative to the rotation of the motor shaft rotation can be enhanced.

In addition, it may also be that the surfaces of the positioning parts facing the upper side are not inclined surfaces positioned on the lower side as the positioning parts approach the protrusion part. In this case, the upward-facing surfaces of the positioning parts are orthogonal to the first direction. Even in such case, the protrusion part can be disposed along the center of the groove part.

In addition, in the first direction, the dimension of the protrusion part of the tip part in a direction orthogonal to the direction in which the protrusion part extends may be the same dimension. Even in such case, the protrusion part can be disposed along the center of the groove part.

The use of the electric actuator to which the invention is applied is not particularly limited. The electric actuator may be mounted in an actuator device of a shift-by-wire method that is driven based on the shift operation of the driver. Additionally, the electric actuator may be mounted to a machine other than a vehicle. It should be noted that the configurations described in the specification can be appropriately combined within a range that does not contradict each other.

It should be noted that this technology can take the following configurations. (1) An electric actuator includes: a motor part, having a rotor capable of rotating with a motor axis as a center; and a housing, accommodating the motor part in the housing. The housing has: a first housing, having an opening part open on one side in a first direction; and a second housing, blocking the opening part and fixed to the first housing. The first housing has: a groove part, having an annular shape, surrounding the opening part, and recessed toward an other side in the first direction; and multiple positioning parts, protruding from an inner surface of the groove part toward a direction intersecting the first direction. The second housing has a protrusion part having an annular shape, protruding toward the other side in the first direction, and disposed inside the groove part. The positioning parts has multiple first positioning parts and multiple second positioning parts, the first positioning parts facing a first surface that faces a side of the opening part in an outer surface of the protrusion part, and the second positioning parts facing a second surface that faces a side opposite to the first surface in the outer surface of the protrusion part. The protrusion part is fixed to the inner surface of the groove part by an adhesive. (2) In the electric actuator of (1), at least one of the positioning parts is in contact with the protrusion part. (3) In the electric actuator of (1) or (2), at least one of the first positioning parts and at least one of the second positioning parts respectively contact the protrusion part. (4) In the electric actuator of any one of (1) to (3), the first positioning parts and the second positioning parts are alternately provided along a direction in which the groove part extends. (5) In the electric actuator of any one of (1) to (4), the groove part has multiple linear parts extending linearly when viewed from the first direction, and the first positioning parts and the second positioning parts are provided at the respective linear parts. (6) In the electric actuator of any one of (1) to (5), a surface of each of the positioning parts facing the one side in the first direction is an inclined surface positioned on the other side in the first direction as the surface approaches the protrusion part. (7) In the electric actuator of any one of (1) to (6), a portion of the protrusion part on the other side in the first direction has a dimension in a direction orthogonal to the direction in which the protrusion part extends that decreases as the portion approaches the other side in the first direction. (8) The electric actuator in any one of (1) to (5) includes: an output shaft, capable of rotating with an output axis as a center; a transmission mechanism, connected with a motor shaft provided in the rotor and the output shaft and transmitting rotation of the motor shaft to the output shaft; and a substrate, supplying current to the motor part. The housing accommodates the output shaft, the transmission mechanism, and the substrate inside the housing.

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. An electric actuator, comprising: a motor part, having a rotor capable of rotating with a motor axis as a center; and a housing, accommodating the motor part in the housing,
wherein the housing has:
a first housing, having an opening part open on one side in a first direction; and
a second housing, blocking the opening part and fixed to the first housing, the first housing has:
a groove part, having an annular shape, surrounding the opening part, and recessed toward an other side in the first direction; and
a plurality of positioning parts, protruding from an inner surface of the groove part toward a direction intersecting the first direction,
the second housing has a protrusion part having an annular shape, protruding toward the other side in the first direction, and disposed inside the groove part,
the positioning parts has a plurality of first positioning parts and a plurality of second positioning parts, the first positioning parts facing a first surface that faces a side of the opening part in an outer surface of the protrusion part, and the second positioning parts facing a second surface that faces a side opposite to the first surface in the outer surface of the protrusion part, and
the protrusion part is fixed to the inner surface of the groove part by an adhesive.

2. The electric actuator as claimed in claim 1, wherein at least one of the positioning parts is in contact with the protrusion part.

3. The electric actuator as claimed in claim 1, wherein at least one of the first positioning parts and at least one of the second positioning parts respectively contact the protrusion part.

4. The electric actuator as claimed in claim 1, wherein the first positioning parts and the second positioning parts are alternately provided along a direction in which the groove part extends.

5. The electric actuator as claimed in claim 1, wherein the groove part has a plurality of linear parts extending linearly when viewed from the first direction, and
the first positioning parts and the second positioning parts are provided at the respective linear parts.

6. The electric actuator as claimed in claim 1, wherein a surface of each of the positioning parts facing the one side in the first direction is an inclined surface positioned on the other side in the first direction as the surface approaches the protrusion part.

7. The electric actuator as claimed in claim 1, wherein a portion of the protrusion part on the other side in the first direction has a dimension in a direction orthogonal to the direction in which the protrusion part extends that decreases as the portion approaches the other side in the first direction.

8. The electric actuator as claimed in claim 1, comprising:
an output shaft, capable of rotating with an output axis as a center;
a transmission mechanism, connected with a motor shaft provided in the rotor and the output shaft and transmitting rotation of the motor shaft to the output shaft; and
a substrate, supplying current to the motor part,
wherein the housing accommodates the output shaft, the transmission mechanism, and the substrate inside the housing.
